(19) United States
(12) Patent Application Publication
(10) Pub. No.: US 2017/0140382 A1
(43) Pub. Date: May 18, 2017

(54) IDENTIFYING TRANSACTIONAL FRAUD UTILIZING TRANSACTION PAYMENT RELATIONSHIP GRAPH LINK PREDICTION

(71) Applicant: International Business Machines Corporation, Armonk, NY (US)

(72) Inventors: SURESH N. CHARI, TARRYTOWN, NY (US); IAN M. MOLLOY, CHAPPAQUA, NY (US)

(21) Appl. No.: 14/938,979

(22) Filed: Nov. 12, 2015

(51) Int. Cl. G06Q 20/40; G06Q 20/38

(52) U.S. Cl. CPC G06Q 20/4016; G06Q 20/382

(57) ABSTRACT

Identifying fraudulent transactions is provided. A transaction payment relationship graph that represents relationships of a plurality of financial transactions between accounts is generated utilizing transaction log data from one or more different transaction channels. A probability is calculated that an edge exists from any account vertex to another account vertex in the transaction payment relationship graph based on features extracted from the transaction payment relationship graph. The calculated probability that the edge exists between account vertices corresponding to the current financial transaction is a vertex link prediction. A fraud score for a current financial transaction is calculated based on the calculated probability that the edge exists between account vertices corresponding to the current transaction.

### BACKGROUND

1. Field

The disclosure relates generally to automatically identifying fraudulent transactions and more specifically to identifying fraudulent transactions by predicting a probability that an edge exists between two account vertices in a transaction payment relationship graph of transaction data corresponding to a plurality of transactions.

2. Description of the Related Art

Traditionally, detecting payment fraud in financial institutions has been based on simple models that are specific to transaction channels (e.g., a credit card transaction channel, an online banking transaction channel, or an automated teller machine transaction channel) and relied on simple statistical models of transactional activity. For example, these statistical and other models focused on statistical properties of the payer in the transaction (e.g., too many transactions in a day), parameters of the transaction (e.g., an account used to perform multiple automated-teller machine withdrawals within a 5 minute period at multiple locations that are geographically distant from each other), or features associated with the transaction channel used to perform the transaction (e.g., Internet Protocol (IP) address of device used to perform an online transaction or indications of malware being present on the device used in the online transaction). Further, these statistical and other models are typically applicable to a single transaction channel with a different fraud model for each channel.

### SUMMARY

According to one illustrative embodiment, a computer-implemented method for identifying fraudulent transactions is provided. A data processing system generates a transaction payment relationship graph that represents relationships of a plurality of financial transactions between accounts utilizing transaction log data from one or more different transaction channels. The data processing system calculates a probability that an edge exists from any account vertex to another account vertex in the transaction payment relationship graph based on features extracted from the transaction payment relationship graph. The calculated probability that the edge exists between account vertices corresponding to the current financial transaction is a vertex link prediction probability. The data processing system calculates a fraud score for a current financial transaction based on this vertex link prediction probability, which may be, for example, inversely proportional to the calculated probability that the edge exists between account vertices corresponding to the current transaction. According to other illustrative embodiments, a data processing system and computer program product for identifying fraudulent transactions are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram of an example transaction payment relationship graph showing vertices corresponding to example transactions between accounts in accordance with an illustrative embodiment;

FIG. 4 is a diagram of an example graph-based fraudulent transaction identification process based on link prediction in accordance with an illustrative embodiment;

FIG. 5 is a diagram of an example of an ego account vertex sub-graph in accordance with an illustrative embodiment;

FIG. 6 is a flowchart illustrating a process for identifying fraudulent transactions in accordance with an illustrative embodiment;

FIG. 7 is a flowchart illustrating another process for identifying a fraudulent transaction in accordance with an alternative illustrative embodiment;

FIG. 8 is a flowchart illustrating another process for identifying a fraudulent transaction in accordance with an alternative illustrative embodiment;

FIG. 9 is a flowchart illustrating another process for identifying a fraudulent transaction in accordance with an alternative illustrative embodiment;

FIG. 10 is a flowchart illustrating another process for identifying a fraudulent transaction in accordance with an alternative illustrative embodiment;

FIG. 11 is a flowchart illustrating a process for calculating a probability that an edge exists between source and destination account vertices in accordance with an illustrative embodiment;

FIG. 12 is a flowchart illustrating another process for calculating a probability that an edge exists between source and destination account vertices in accordance with an alternative illustrative embodiment;

FIG. 13 is a flowchart illustrating another process for calculating a probability that an edge exists between source and destination account vertices in accordance with an alternative illustrative embodiment;

FIG. 14 is a flowchart illustrating another process for calculating a probability that an edge exists between source and destination account vertices in accordance with an alternative illustrative embodiment; and

FIG. 15 is a flowchart illustrating a process for calculating a likelihood of fraud for a current financial transaction in accordance with an alternative illustrative embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer readable program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

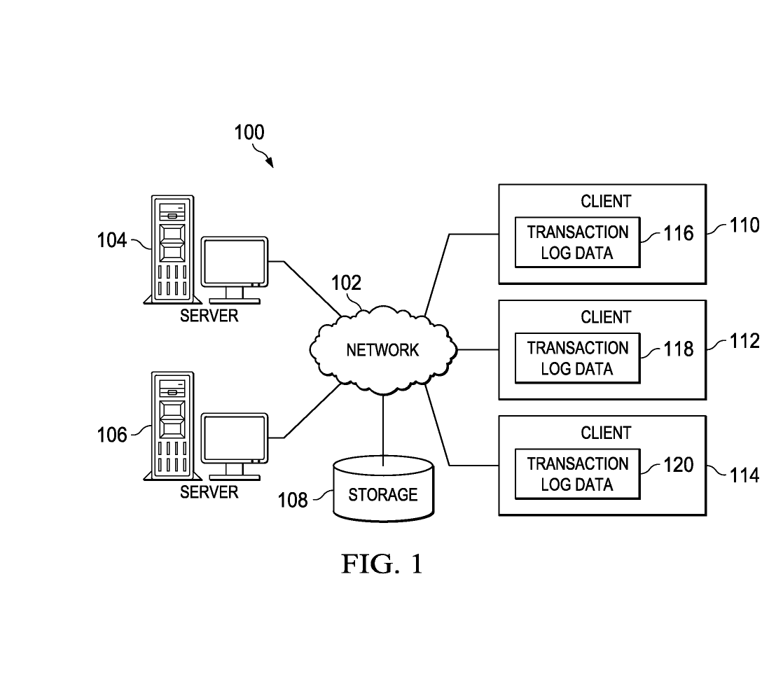

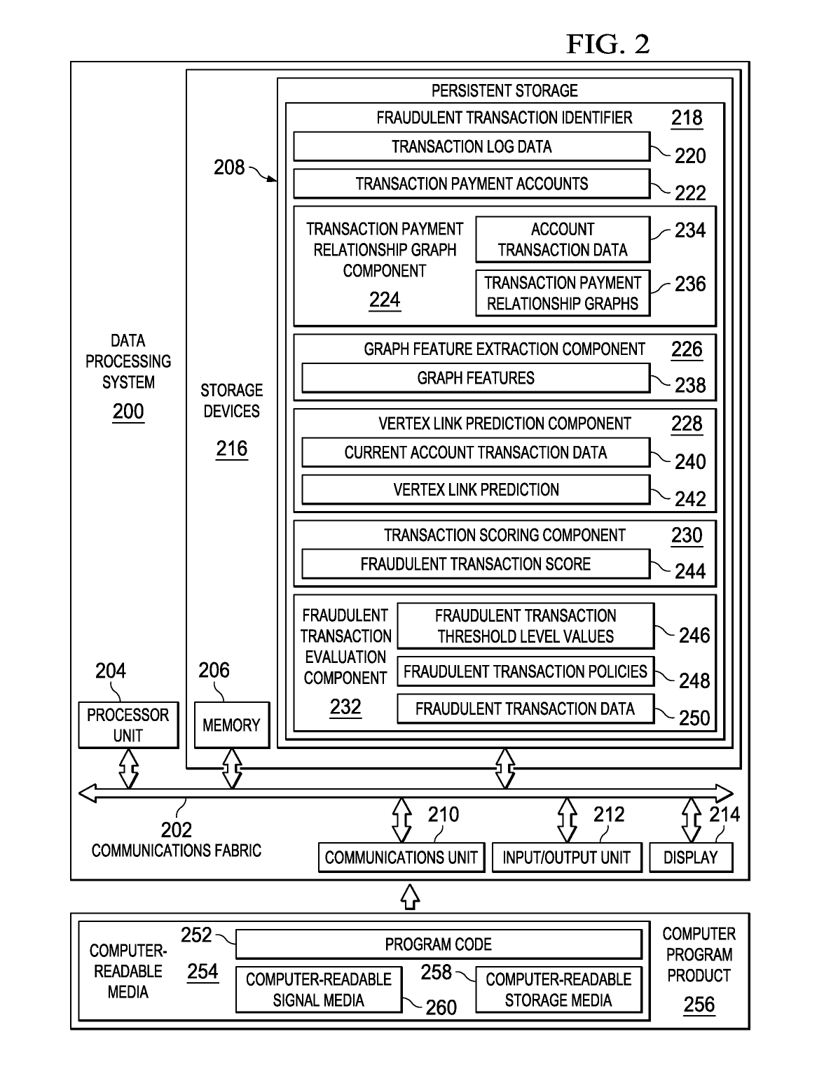

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers and other devices in which the illustrative embodiments may be implemented. Network data processing system 100 contains network 102, which is the medium used to provide communications links between the computers and the other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. In addition, server 104 and server 106 may provide services, such as, for example, services that automatically identify fraudulent financial transactions being performed on registered client devices based on predicting a probability that an edge exists between two account vertices in a transaction payment relationship graph. Further, in response to identifying a fraudulent financial transaction, server 104 and server 106 may block the fraudulent financial transaction from being performed or may take action to mitigate a risk of allowing the fraudulent transaction to occur.

Client device 110, client device 112, and client device 114 also connect to network 102. Client devices 110, 112, and 114 are registered clients of server 104 and server 106. Server 104 and server 106 may provide information, such as boot files, operating system images, and software applications to client devices 110, 112, and 114.

Client devices 110, 112, and 114 may be, for example, computers, such as network computers or desktop computers with wire or wireless communication links to network 102. However, it should be noted that client devices 110, 112, and 114 are intended as examples only. In other words, client devices 110, 112, and 114 also may include other devices, such as, for example, automated teller machines, point-of-sale terminals, kiosks, laptop computers, handheld computers, smart phones, smart watches, personal digital assistants, gaming devices, or any combination thereof. Users of client devices 110, 112, and 114 may use client devices 110, 112, and 114 to perform financial transactions, such as, for example, transferring monetary funds from a source or paying financial account to a destination or receiving financial account to complete a financial transaction.

In this example, client device 110, client device 112, and client device 114 include transaction log data 116, transaction log data 118, and transaction log data 120, respectively. Transaction log data 116, transaction log data 118, and transaction log data 120 are information regarding financial transactions performed on client device 110, client device 112, and client device 114, respectively. The transaction log data may include, for example, financial transactions performed on a point-of-sale terminal, financial transactions performed on an automated teller machine, credit card account transaction logs, bank account transaction logs, online purchase transaction logs, mobile phone transaction payment logs, and the like.

Storage 108 is a network storage device capable of storing any type of data in a structured format or an unstructured format. In addition, storage 108 may represent a set of one or more network storage devices. Storage 108 may store, for example, historic transaction log data, real-time transaction log data, lists of financial accounts used in financial transactions, names and identification numbers of financial account owners, financial transaction payment relationship graphs, vertex link predictions, scores for financial transactions based on the vertex link predictions, and fraudulent financial transaction threshold level values. Further, storage unit 108 may store other data, such as authentication or credential data that may include user names, passwords, and biometric data associated with users and system administrators.

In addition, it should be noted that network data processing system 100 may include any number of additional server devices, client devices, and other devices not shown. Program code located in network data processing system 100 may be stored on a computer readable storage medium and downloaded to a computer or other data processing device for use. For example, program code may be stored on a computer readable storage medium on server 104 and downloaded to client device 110 over network 102 for use on client device 110.

In the depicted example, network data processing system 100 may be implemented as a number of different types of communication networks, such as, for example, an internet, an intranet, a local area network (LAN), and a wide area network (WAN). FIG. 1 is intended as an example, and not as an architectural limitation for the different illustrative embodiments.

With reference now to FIG. 2, a diagram of a data processing system is depicted in accordance with an illustrative embodiment. Data processing system 200 is an example of a computer, such as server 104 or client 110 in FIG. 1, in which computer readable program code or program instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 206, in these examples, may be, for example, a random access memory, or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores fraudulent transaction identifier 218. Fraudulent transaction identifier 218 monitors financial transaction data to identify and block a fraudulent financial transaction by generating a score for a current financial transaction based on predicting a probability that an edge exists between two account vertices corresponding to the current financial transaction in a transaction payment relationship graph. Instead of or in addition to blocking the identified financial transaction, fraudulent transaction identifier 218 may forward the identified financial transaction to an appropriate fraud risk management system. In this example, fraudulent transaction identifier 218 includes transaction log data 220, transaction payment accounts 222, transaction payment relationship graph component 224, graph feature extraction component 226, vertex link prediction component 228, transaction scoring component 230, and fraudulent transaction evaluation component 232. However, it should be noted that the data and components included in fraudulent transaction identifier 218 are intended as examples only and not as limitation on different illustrative embodiments. For example, fraudulent transaction identifier 218 may include more or fewer data or components than illustrated. For example, two or more components may be combined into a single component.

Transaction log data 220 may be, for example, transaction log data of financial transactions performed on and received from a set of one or more client devices via a network, such as transaction log data 116, transaction log data 118, and/or transaction log data 120 received from client device 110, client device 112, and/or client device 114 via network 102 in FIG. 1. Fraudulent transaction identifier 218 may obtain transaction log data 220 from one-or-more channels of financial transactions or transaction channels that may include, for example, point-of-sale terminals, automated teller machines, credit card account computers, bank account computers, online purchase log computers, mobile phone payment computers, and the like. Alternatively, transaction log data 220 may be transaction log data of financial transactions performed on data processing system 200.

Transaction payment accounts 222 list financial accounts corresponding to the financial transactions associated with transaction log data 220. For example, transaction payment accounts 222 may include both source or paying financial accounts and destination or receiving financial accounts involved in financial transactions listed in transaction log data 220.

Transaction payment relationship graph component 224 retrieves account transaction data 234 from transaction log data 220 or directly from financial transaction client devices. Account transaction data 234 identify the particular financial accounts (i.e., source and destination accounts) involved in each financial transaction. Transaction payment relationship graph component 224 generates a set of one or more transaction payment relationship graphs, such as transaction payment relationship graphs 236. A transaction payment relationship graph illustrates payment relationships between vertices corresponding to financial accounts involved in the financial transactions of account transaction data 234. A transaction payment relationship graph may be, for example, a compact transaction graph, an account owner transaction graph, or a multi-partite graph.

Graph feature extraction component 226 extracts graph features 238 from transaction payment relationship graphs 236. In response to vertex link prediction component 228 receiving current account transaction data 240, vertex link prediction component 228 retrieves information regarding extracted graph features 238 from graph feature extraction component 226 for use in generating vertex link prediction 242 for the current financial transaction being performed. Current account transaction data 240 are information corresponding to a current financial transaction being transacted between financial accounts. Vertex link prediction 240 is a percentage probability that an edge exists between two vertices in transaction payment relationship graphs 236 corresponding to current account transaction data 240. After vertex link prediction component 228 generates vertex link prediction 242, vertex link prediction component 228 forwards vertex link prediction 242 to transaction scoring component 230.

In response to transaction scoring component 230 receiving vertex link prediction 242, transaction scoring component 228 generates fraudulent transaction score 244 for the current financial transaction being performed based on vertex link prediction 242. After transaction scoring component 230 generates fraudulent transaction score 244 for the current financial transaction, transaction scoring component 230 forwards fraudulent transaction score 244 to fraudulent transaction evaluation component 232. Fraudulent transaction evaluation component 232 analyzes fraudulent transaction score 244 to determine whether fraudulent transaction score 244 indicates whether the current financial transaction is fraudulent. For example, fraudulent transaction evaluation component 232 may compare fraudulent transaction score 244 to fraudulent transaction threshold level values 246 to determine whether the current financial transaction is fraudulent. If fraudulent transaction score 244 is equal to or greater than one of fraudulent transaction threshold level values 246, than fraudulent transaction evaluation component 232 determines that the current financial transaction is fraudulent.

In response to fraudulent transaction evaluation component 232 determining that the current financial transaction is fraudulent, fraudulent transaction evaluation component 232 may utilize, for example, fraudulent transaction policies 248 to determine which action to take regarding the current financial transaction. For example, fraudulent transaction policies 248 may direct fraudulent transaction evaluation component 232 to block any current financial transaction with a fraudulent transaction score equal to or greater than a fraudulent transaction threshold level value. Alternatively, fraudulent transaction policies 248 may direct fraudulent transaction evaluation component 232 to mitigate a risk associated with the current financial transaction with a fraudulent transaction score equal to or greater than a fraudulent transaction threshold level value by sending a notification to an owner of the source or paying financial account requesting confirmation to allow the current financial transaction. Fraudulent transaction evaluation component 232 stores fraudulent transaction data 250. Fraudulent transaction data 250 lists all fraudulent financial transactions previously identified by fraudulent transaction evaluation component 232 for reference by fraudulent transaction identifier 218.

Communications unit 210, in this example, provides for communication with other computers, data processing systems, and devices via a network, such as network 102 in FIG. 1. Communications unit 210 may provide communications using both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (Wi-Fi), bluetooth technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer implemented program instructions, which may be located in a memory, such as memory 206. These program instructions are referred to as program code, computer usable program code, or computer readable program code that may be read and run by a processor in processor unit 204. The program code, in the different embodiments, may be embodied on different physical computer readable storage devices, such as memory 206 or persistent storage 208.

Program code 252 is located in a functional form on computer readable media 254 that is selectively removable and may be loaded onto or transferred to data processing system 200 for running by processor unit 204. Program code 252 and computer readable media 254 form computer program product 256. In one example, computer readable media 254 may be computer readable storage media 258 or computer readable signal media 260. Computer readable storage media 258 may include, for example, an optical or magnetic disc that is inserted or placed into a drive or other device that is part of persistent storage 208 for transfer onto a storage device, such as a hard drive, that is part of persistent storage 208. Computer readable storage media 258 also may take the form of a persistent storage, such as a hard drive, a thumb drive, or a flash memory that is connected to data processing system 200. In some instances, computer readable storage media 258 may not be removable from data processing system 200.

Alternatively, program code 252 may be transferred to data processing system 200 using computer readable signal media 260. Computer readable signal media 260 may be, for example, a propagated data signal containing program code 252. For example, computer readable signal media 260 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 252 may be downloaded over a network to persistent storage 208 from another device or data processing system through computer readable signal media 260 for use within data processing system 200. For instance, program code stored in a computer readable storage media in a data processing system may be downloaded over a network from the data processing system to data processing system 200. The data processing system providing program code 252 may be a server computer, a client computer, or some other device capable of storing and transmitting program code 252.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 258 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Illustrative embodiments are based on the hypothesis that a successful payment for a financial transaction between two financial accounts establishes a trust relationship between the two accounts and the trust relationship relies only on the entities making the successful payment. The trust relationship between the two accounts does not depend on the type of transaction channel used to perform the financial transaction or on any other parameter corresponding to the financial transaction. A source or paying account “trusts” the destination or receiving accounts or entities that the source account pays directly most often and greatest amounts transferred.

Illustrative embodiments may utilize this or a similar “trust model” to identify and graphically depict trust relationships between financial accounts. Payment relationships define a community for each account comprising a set of one or more accounts with which a particular account performs financial transactions on a regular basis. Illustrative embodiments may flag financial accounts or transactions outside a defined community for a particular account as anomalous and potentially fraudulent.

For example, illustrative embodiments may aggregate financial transaction data occurring in various different types of transaction channels, such as automated teller machines, credit cards, and mobile phone payments, into a single graph that represents payment relationships. Illustrative embodiments use features extracted from the constructed transaction payment relationship graph to subsequently score other transactions based on predicting a probability that an edge exists between two account vertices corresponding to a current financial transaction in the constructed transaction payment relationship graph. Computing the probability, using one or more graph features, that an edge exists between two account vertices corresponding to a current financial transaction is called vertex link prediction. Illustrative embodiments utilize transaction fraud scores that are based on the vertex link predictions to identify fraudulent payments.

Illustrative embodiments utilize this predicted probability of a link between vertices in fraudulent transaction detection scoring by using any scoring function where the probability of a current financial transaction being fraudulent is inversely proportional to the probability that a link between the transaction endpoint vertices is predicted. In other words, the higher the probability that an edge/link exists between two vertices corresponding to a current financial transaction in the transaction payment relationship graph, the lower the probability that the current transaction between the two vertices is fraudulent. However, it should be noted that if the predicted probability of a link between vertices and the predicted probability that a current transaction is fraudulent are both [0-1], then illustrative embodiments may take 1-p, learn relationships using trained data, fit to some curve, et cetera. Illustrative embodiments may utilize several methods to perform vertex link prediction based on various graph features and to identify the right sub-graph around a particular financial transaction and use features of that sub-graph.

Thus, illustrative embodiments provide a transaction channel independent mechanism for detecting transaction fraud by utilizing an extracted set of features based on relationships between account vertices in a transaction payment relationship graph to predict whether an edge exists between account vertices, which increases the accuracy of transaction fraud detection. Transaction channel independence allows for more robust models of fraud detections that work at a higher level, such as, for example, who pays whom. This allows illustrative embodiments to perform fraud detection at the account level. In addition, because the analytics of illustrative embodiments are based on extracted features of the transaction payment relationship graph, illustrative embodiment analytics are more accurate than rules.

Illustrative embodiments collect, aggregate, and analyze transaction log data from one or more different types of transaction channels, such as point-of-sale terminals, automated teller machines transactions, online payments, mobile payments, and the like. Illustrative embodiments may include all transaction and payment systems, which have an auditable “paper trail” and can be uniquely associated with a particular financial account. Illustrative embodiments generate transaction payment relationship graphs using the collected transaction log data to capture transaction payment relationships during a set of one or more periods of defined time intervals that are of interest.

The transaction log data from the various different types of transaction channels may contain the following information: 1) identification of a source account for a transaction from which monetary funds are taken to pay for the transaction and identification of an owner or owners corresponding to the source account (Illustrative embodiments assume the source account to be non-null having available funds to execute a financial transaction); 2) identification of a destination account, which receives payment from the source account, for the transaction and identification of an owner corresponding to the destination account (A destination for a transaction may include, for example, a point-of-sale terminal, an automated teller machine, or other specially designated values for other specific transaction channels. Illustrative embodiments can map these special destinations to a destination account based on channel specific information. For example, illustrative embodiments associate the point-of-sale terminal with an account of the merchant owning the point-of-sale terminal or associates an automated teller machine destination with a special automated teller machine account which is associated with each account); 3) an indication of whether a transaction was a credit or debit transaction; 4) a timestamp for the transaction (Illustrative embodiments may utilize the timestamp for each transaction channel to assist in generating a transaction payment relationship graph. Many possible timestamps associated with a transaction may exist, such as, for example, a timestamp for when the transaction occurred, a timestamp for when the transaction was recorded, a timestamp for when monetary funds where taken from the source account and transmitted to the destination account, a timestamp for when the transaction was officially considered committed, and any such similar timestamp. To construct a transaction payment relationship graph, illustrative embodiments choose one ‘canonical’ timestamp which may be different for each channel and use that timestamp); and 5) a transaction amount for each transaction in a currency, such as dollars, euros, and the like.

Besides the transaction log data mentioned above, the transaction log data also may include other data that capture finer details about the accounts involved in a particular transaction, the specific type of transaction, and/or information regarding the specific type of channel used to conduct the transaction. Illustrative embodiments may leverage this optional data to augment the process for transaction scoring.

Following are some examples of this optional data. Information regarding the source account and/or the destination account. For example, the information regarding the accounts may include the type of accounts, a location of an account in the case of point-of-sale terminals or automated teller machines, or any other pertinent account information. It is easy to see how illustrative embodiment may utilize such optional data in fraudulent transaction scoring. For example, illustrative embodiments may customize every fraud scoring method to consider only financial transactions of a certain type. Similarly, illustrative embodiments may utilize location information to score a financial transaction. For example, illustrative embodiments may utilize an impossible geography analytic to determine whether a set of two or more financial transactions performed at different automated teller machine at different locations are fraudulent.

Further, the optional data may include information about a particular transaction, such as, for example, whether the particular transaction was performed in a foreign country. Furthermore, the optional data may include information regarding a particular transaction channel used to conduct the financial transaction, such as channel specific information that is captured along with each channel. Illustrative embodiments may utilize such information to annotate a particular transaction with features. Examples of transaction channel specific features may include details of the computer used to perform an online banking transaction, details of the network, such as internet protocol (IP) address, and the like.

For each financial transaction, illustrative embodiments develop a relationship between the source account and the destination account and label the transaction with features, such as a timestamp corresponding to a particular transaction, the amount of monetary funds involved in the transaction, and any other optional data provided in the transaction log data. It may be necessary for illustrative embodiments to adjust the transaction log data so that every financial transaction record has a distinct source account and destination account. For example, it is preferable to have a “unique account’ to identify each point-of-sale terminal, which illustrative embodiments do by assigning some unique identifying information to each particular point-of-sale terminal, such as the physical location of each particular point-of-sale terminal.

Illustrative embodiments handle automated teller machine transactions differently as automated teller machine transactions represent cash being taken out of a source account and spent anonymously. The approach with automated teller machine transactions is to generate a vertex in a transaction payment relationship graph for each source account and uniquely label the vertex as, for example, “<account-number>.CASH” or using a similar scheme to generate a unique label for each account number's automated teller machine transaction.

One illustrative embodiment utilizes transaction log data to build a transaction payment relationship graph to represent financial transactions either directly by representing each financial account as a vertex in the graph with an edge between two endpoint vertices of a financial transaction or with a vertex representing a financial transaction with an incoming edge from a source account vertex corresponding to a paying financial account and an outgoing edge to a destination account vertex corresponding to a receiving financial account. Illustrative embodiments may utilize any method that is able to calculate a probability that an edge exists from any vertex to another vertex in the transaction payment relationship graph. In addition, illustrative embodiments may utilize a fraud scoring function that is typically inversely proportional to the predicted probability that an edge exists between vertices corresponding to a current financial transaction. The fraud scoring function may be, for example, a threshold function where illustrative embodiments label a financial transaction as fraudulent when the predicted probability that an edge exists between vertices corresponding to a current financial transaction is less than a predefined probability threshold value. Alternatively the fraud scoring function may be a machine learning classifier trained on previously labeled fraudulent financial transactions.

In another illustrative embodiment, the probability of adding an edge to the transaction payment relationship graph may be viewed as proportional to the local edge density of the graph. Illustrative embodiments may define the density of the transaction payment relationship graph by the ratio of the number of edges to the number of vertices. If a sub-graph is dense, especially if many vertices exist in the sub-graph, then adding one more edge has a small impact on the sub-graph.

In one illustrative embodiment, the vertex link prediction is based on features of the two endpoint vertices of a particular financial transaction. The features of the two endpoint vertices (e.g., the source and destination account vertices) may include features, such as, for example, the type of accounts corresponding to the vertices, the geographic locations of the accounts, and the type of merchant. Illustrative embodiments may train the machine learning classifier to determine if an account with a first set of features will pay another account with a second set of features.

In another illustrative embodiment, the vertex link prediction is based on degree features of the two endpoint vertices. For example, the vertex link prediction may be based on out-degree of the source account vertex and/or the in-degree of the destination account vertex. The probability that an edge exists between the two endpoint vertices corresponding to a current financial transaction is proportional to the out-degree of the source account vertex and the in-degree of the destination account vertex. Higher out-degrees of source account vertices and higher in-degrees of destination account vertices imply that corresponding transactions are less likely to be fraudulent.

In another illustrative embodiment, the vertex link prediction is based on the structure of the transaction payment relationship graph. There are many special graph structures that a transaction payment relationship graph may take. For example, a k-partite graph will divide the vertices into k number of sets, such that any edge representing a financial transaction must occur between two vertices representing financial accounts drawn from different or specific sets of vertices. For example, an account corresponding to an account vertex in set of account vertices_1 can only pay an account corresponding to an account vertex in set of account vertices_2, and an account corresponding to an account vertex in set of account vertices_2 can only pay an account corresponding to an account vertex in set of account vertices_3. Any account corresponding to an account vertex in set of account vertices_1 attempting to pay an account corresponding to an account vertex in set of account vertices_3 violates this principle and is an indication of a fraudulent transaction.

There are other graph structures that a transaction payment relationship graph may take, such as, for example, planar graphs, scale free graphs, clique graphs, hub-and-spoke graphs, and the like, which have measurable or enforced properties. If the transaction payment relationship graph or a sub-graph containing the source and destination account vertices will be violated by adding an edge, then illustrative embodiments do not predict the existence of an edge between the source and destination account vertices. In other words, illustrative embodiments predict the existence of an edge proportional to the probability that the edge would be added (i.e., generated) by a model for generating the transaction payment relationship graph.

In another illustrative embodiment, the vertex link prediction is based on the number of distinct edges that connect two account vertices in the transaction payment relationship graph.

Illustrative embodiments may cluster an edge adjacency matrix and calculate the vertex link prediction proportional to an edge cluster density value. For example, illustrative embodiments may represent a transaction payment relationship graph as a matrix M, where the matrix value M[i,j] is equal to zero (0) if no edge exists from vertex i to vertex j, and the matrix value M[i,j] is greater than zero if an edge does exist from vertex i to vertex j. The latter matrix value may be binary (1), which indicates the presence of an edge, the number of times an account corresponding to vertex i has paid an account corresponding to vertex j in a specified time range, the total amount of money the account corresponding to vertex i has paid the account corresponding to vertex j in the specified time range, et cetera.

By co-clustering the edge adjacency matrix, illustrative embodiments may define tiles or regions, which may be disjointed, in the matrix. If [i,j] does not fall within a tile, then illustrative embodiments do not predict that an edge exists. If [i,j] does fall within a tile, then illustrative embodiments may estimate the edge cluster density value of [i,j] by the edge density of the tile that the edge [i,j] belongs to. An example would be to apply k-means clustering to the rows and columns of the matrix independently or use a co-clustering algorithm, such as an infinite relational model. A relaxation of the infinite relational model would be to allow an edge to belong to more than one cluster using multi-assignment clustering.

Where illustrative embodiments apply low rank matrix factorization, such as singular value decomposition (SVD) or non-negative matrix factorization (NMF), to the edge adjacency matrix, illustrative embodiments may calculate the vertex link prediction proportional to the edge cluster density value in the reconstructed edge adjacency matrix. Matrix factorization techniques are an alternative to using co-clustering. These matrix factorization techniques decompose a matrix M≈U*V̂T=M′, where the value of U and V are small, k. The smaller k, the more coarse-grained the approximation. By using a low-rank matrix factorization decomposition, illustrative embodiments may approximate the edge cluster density value of the edge M[i,j] using M′[i,j].

Illustrative embodiments apply tensor decomposition to a set of financial transactions of the transaction payment relationship graph and calculate the vertex link prediction proportional to a vertex link prediction value in a reconstructed tensor. A tensor is a multidimensional matrix. The additional dimension may define, for example, units of time, such as one day for multiple days, features of accounts, ownership, et cetera. Tensor decomposition works as a generalized matrix factorization and the process is similar.

In another illustrative embodiment, the vertex link prediction is based on features of accounts, edges, and graph structure. Illustrative embodiments apply collective matrix factorization to relationships between the features of the accounts, edges, and structure of the transaction payment relationship graph and calculate the vertex link prediction proportional to a reconstructed edge cluster density value in the edge adjacency matrix. Collective matrix factorization is a generalized matrix factorization method where multiple related matrices are decomposed together. For example, illustrative embodiments may utilize the collective matrix factorization to decompose an account-account matrix M, along with an account-ownership matrix and/or an account-type matrix. This collective matrix factorization technique allows information corresponding to all feature relationships to affect the decomposed matrix value of M to improve accuracy.

Illustrative embodiments may calculate the vertex link prediction proportional to a confidence value corresponding to association rules mined from features corresponding to a set of destination account vertices for each source account vertex. Association rules discover relationships between sets of account features, such as accounts paid, that imply the paying of other accounts. For example, source accounts that paid destination accounts {A_1, A_2, . . . , A_i} also may pay destination accounts {A_j, . . . , A_k} corresponding to vertices having a given link probability. For a financial transaction where source account i pays destination account j, illustrative embodiments will find all association rules that contain destination account j as a consequence (the A_j-set) and will determine whether source account i has paid all accounts in the antecedent destination account set (the A_1-set). Illustrative embodiments find all such association rules that apply. Illustrative embodiments calculate the vertex link prediction proportional to the confidence value. Illustrative embodiments apply an ensemble that combines such association rules, possibly through another learning method. To generate the association rules, illustrative embodiments may use an algorithm, such as FP-growth.

Illustrative embodiments may apply sequence mining to a temporally ordered set of destination accounts that a source account pays. Sequence mining is very similar to association rules, except that the order or time in which the transactions occurred is important. This sequence mining will find ordered transactions corresponding to accounts that must be paid prior to paying another account. The sequence mining scoring is similar to the association rules scoring above.

Illustrative embodiments also may apply the vertex link prediction process to a sub-graph of the transaction payment relationship graph. The illustrative embodiments build the sub-graph from all financial transaction and account information corresponding to account vertices within k number of hops of source and destination account vertices corresponding to the current financial transaction.

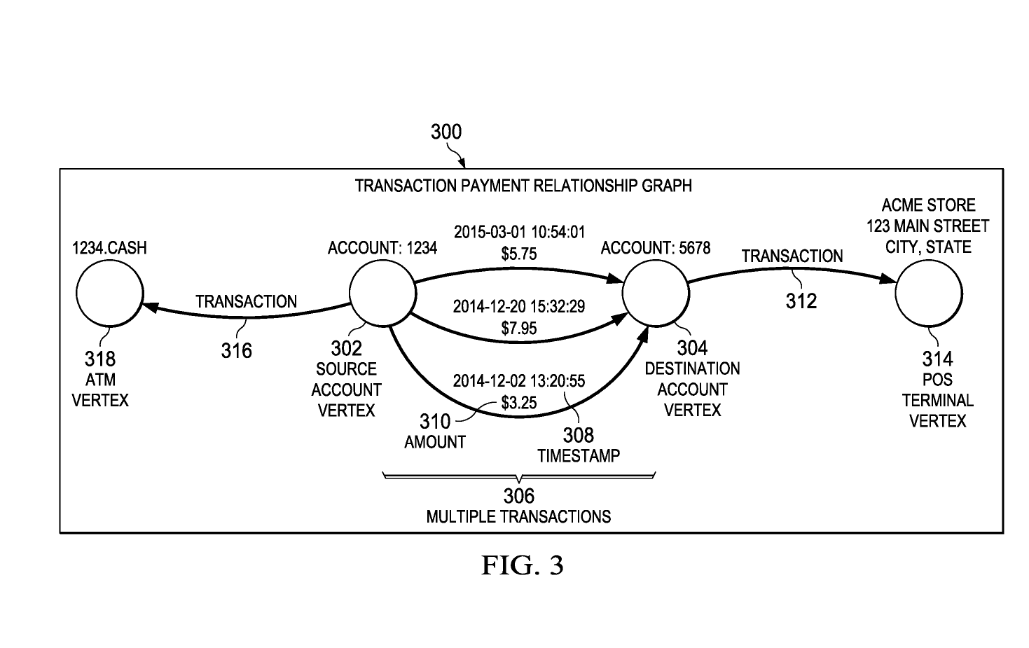

With reference now to FIG. 3, a diagram of an example transaction payment relationship graph showing vertices corresponding to example transactions between accounts is depicted in accordance with an illustrative embodiment. Transaction payment relationship graph 300 may be, for example, one of the transaction payment relationship graphs in transaction payment relationship graphs 234 in FIG. 2.

In this example, transaction payment relationship graph 300 includes source account vertex 302 and destination account vertex 304. Source account vertex 302 represents account “1234” and destination account vertex 304 represents account “5678”. Accounts “1234” and “5678” have multiple transactions 306 performed between them. Illustrative embodiments label each transaction in multiple transactions 306 between accounts “1234” and “5678” with a timestamp, such as timestamp 308 “2014-12-02 13:20:50” and an amount, such as amount 310 “$3.25”.

Transaction payment relationship graph 300 also shows transaction 312 between account “5678” and a point-of-sale terminal, which corresponds to point-of-sale terminal vertex 314. “ACME STORE 123 MAIN STREET, CITY, STATE” is the label for point-of-sale terminal vertex 314 that uniquely identifies the point-of-sale terminal and its physical location. Similarly, account “1234” performs transaction 316 with an automated teller machine corresponding to automated teller machine vertex 318 labeled “1234.CASH”. Transaction 316 indicates that an owner of account “1234” has withdrawn some money from account “1234”. Transactions 312 and 316 do not show an amount or a timestamp, which are features for the edges inserted between the vertices.

An alternative illustrative embodiment may generate a compact owner transaction payment relationship graph. This construct associates with each vertex an owner or owners and associates in the relationship graph an edge in the transaction graph between a vertex corresponding to an owner of a source account and a vertex corresponding to an owner of a destination account, which more directly captures the idea of a payment relationship between account owners. It should be noted that as a simplification, the alternative illustrative embodiment may generate a compact owner transaction payment relationship graph only for accounts where the owner is easily identifiable. In addition, the alternative illustrative embodiment may insert special vertices into the compact owner transaction payment relationship graph for automated teller machine and point-of-sale transactions as described above.

Another alternative illustrative embodiment may generate a complex multi-partite transaction payment relationship graph, which is intended to capture as much information about transactions, transaction channels, and accounts into a single graph. In a complex multi-partite graph representation, vertices may be one of many different types (stored as a feature of a vertex) including the following: 1) transaction vertices, wherein each financial transaction is represented as a vertex; 2) account vertices, representing various financial accounts, including special accounts created for automated teller machines, point-of-sale terminals, and other such transactions; and 3) owner vertices, representing individuals or entities that own the accounts.

In addition, there may be other optional vertex types, such as device vertices that represent fingerprints of devices used to perform online transactions. The devices used to perform the online transactions may be, for example, desktop computers, handheld computer, or smart phones. Account vertices, owner vertices, and device vertices may include a set of one or more features, such as account types, owner addresses, and device characteristics, which illustrative embodiments may add to a transaction payment relationship graph. For each transaction, illustrative embodiments generate a new vertex that includes a set of features, such as, for example, a timestamp corresponding to the transaction, a transaction identification number, and an amount of the transaction. Illustrative embodiments also insert an edge from a source account vertex to a new transaction vertex and insert an edge from the new transaction vertex to a destination account vertex. If the transaction is associated with other vertex types, such as a device vertex, then illustrative embodiments generate a bidirectional edge between the transaction vertex and the associated device vertex or other vertices. Multi-partite transaction payment relationship graphs are more complex, but these types of graphs capture more fine-grained information that some illustrative embodiments may use in fraud scoring analytics.

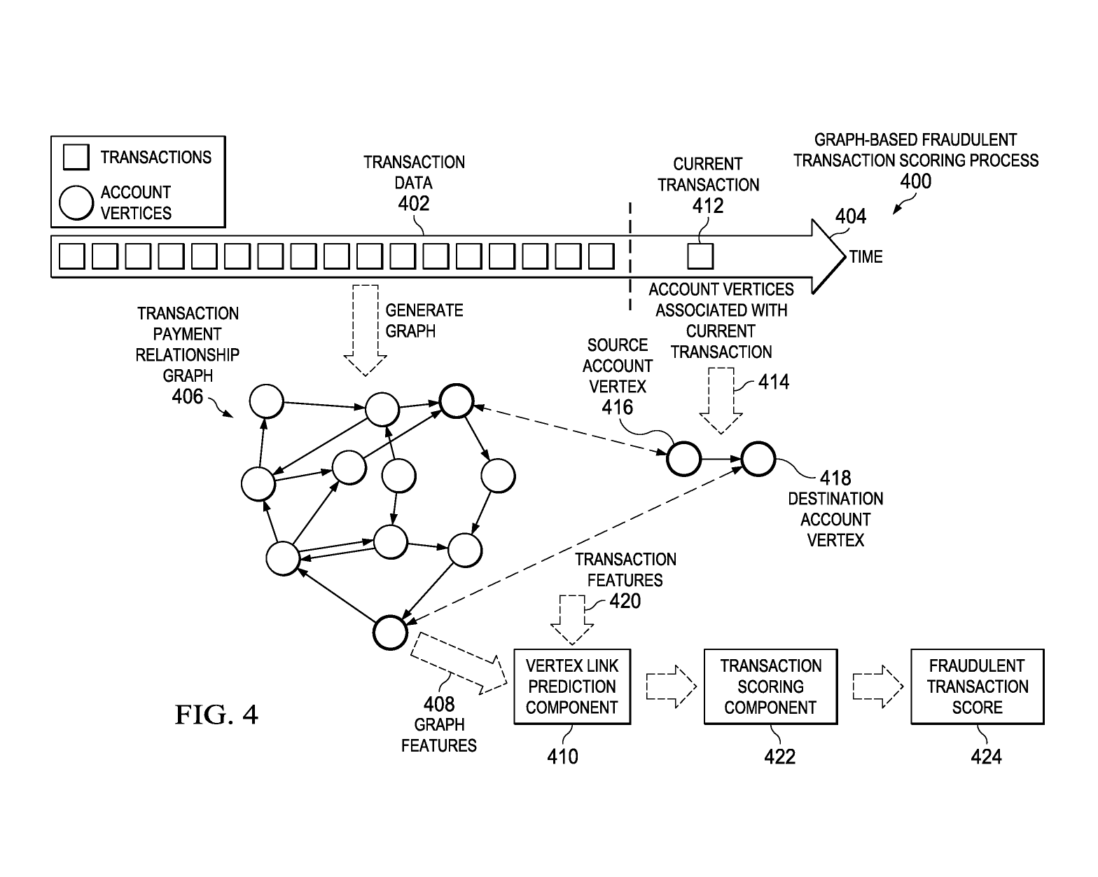

With reference now to FIG. 4, a diagram of an example graph-based fraudulent transaction identification process based on link prediction is depicted in accordance with an illustrative embodiment. Graph-based fraudulent transaction scoring process 400 may be implemented in a network of data processing systems, such as, for example, network data processing system 100 in FIG. 1. Alternatively, graph-based fraudulent transaction scoring process 400 may be implemented in a single data processing system, such as, for example, data processing system 200 in FIG. 2.

Graph-based fraudulent transaction scoring process 400 illustrates a high-level overview of financial transaction scoring performed by illustrative embodiments. Squares in the diagram of FIG. 4 represent transactions, while circles represent account vertices. Illustrative embodiments divide time into discrete units of time or time intervals to scope the transaction payment relationship graphs generated from transaction data, score transactions, and build ensembles. Illustrative embodiments utilize transaction data 402, which illustrative embodiments aggregate over time, such as time 404, to generate transaction payment relationship graph 406. Transaction data 402 may be, for example, transaction log data 220 in FIG. 2. Transaction payment relationship graph 406 is similar to transaction payment relationship graph 300 in FIG. 3.

Illustrative embodiments generate transaction payment relationship graph 406 based on transaction data 402, which corresponds to financial transactions that occurred in the past. For a current financial transaction to be scored, such as current transaction 412, illustrative embodiments extract graph features 408 corresponding to current transaction 412 from transaction payment relationship graph 406. Illustrative embodiments input information regarding graph features 408 into vertex link prediction component 410. Vertex link prediction component 410 may be, for example, vertex link prediction component 228 in FIG. 2.

In parallel, illustrative embodiments identify account vertices associated with current transaction 414 in transaction payment relationship graph 406. In this example, account vertices associated with current transaction 414 are source account vertex 416 and destination account vertex 418. Illustrative embodiments extract graph-based transaction features 420 corresponding to source account vertex 416 and destination account vertex 418. Illustrative embodiments also input information regarding extracted graph-based transaction features 420 into vertex link prediction component 410. Vertex link prediction component 410 calculates a probability that an edge exists between source account vertex 416 and destination account vertex 418 corresponding to current transaction 412. Afterward, vertex link prediction component 410 outputs the vertex link prediction of the probability that an edge exists between source account vertex 416 and destination account vertex 418 to transaction scoring component 422.

Transaction scoring component 422 uses the vertex link prediction to generate fraudulent transaction score 424. Transaction scoring component 422 may be, for example, transaction scoring component 230 in FIG. 2. Fraudulent transaction score 424 indicates whether current transaction 412 is fraudulent or not. A fraudulent transaction evaluation component, such as fraudulent transaction evaluation component 230 in FIG. 2, may block current transaction 412, or otherwise mitigate current transaction 412, when fraudulent transaction score 424 is greater than or equal to a predefined fraudulent transaction threshold score. The fraudulent transaction evaluation component may mitigate current transaction 412 by interrupting current transaction 412 and sending a notification to an owner of the source or paying account corresponding to source account vertex 416 requesting authorization to proceed with current transaction 412 or to block and cancel current transaction 412.

To score a transaction (t) from a source account (A) to a destination account (B) which correspond to vertices (X) and (Y) relative to a transaction payment relationship graph (G), illustrative embodiments calculate features (F) corresponding to vertices X and Y, and the pair of vertices <X, Y>, relative to the graph G. Calculated features may include, but are not limited to, the following:

1) F_{G}(X) and F_{G}(Y), features corresponding to the vertices X and Y. For example, the number of neighboring vertices or the number of associated edges in the graph G.
2) ΔF_{G1, . . . , Gn}(X) and ΔF_{G1, . . . , Gn}(Y), how the features change given a set of different time window transaction graphs G₁ . . . Gₙ that may be taken from different time periods or lengths of transactions.
3) ‘A(F)_{G}(X) and ‘A(F)_{G}(Y), anomaly scores for the features F corresponding to vertices X and Y. For example, a feature, such as the ratio of the number of distinct accounts transacted with and the total monetary value of the transactions may make an account an anomaly compared to other accounts in the graph G.
4) F_{G}<<X,Y>>, features corresponding to the pair of vertices <X, Y> in the graph G. For example, the amount of money that flows from source vertex X corresponding to the source account A to destination vertex Y corresponding to destination account B through another vertex Z.

To score current financial transactions, illustrative embodiments utilize a fraud scoring function, S( ), which takes as input the features extracted from a set of one or more transaction payment relationship graphs for a given current transaction, and outputs a score indicating a level of fraud associated with the given current transaction (i.e., whether the given current transaction is fraudulent or not). Such fraud scoring functions can be defined in either an unsupervised or a supervised manner. Possible examples of supervised fraud scoring functions S( ) may include logistic regression or support vector machines. These supervised machine learning systems require a set of labeled transactions (i.e., known instances of fraudulent transactions, such as fraudulent transaction data 246 in FIG. 2) to train a classifier. Once trained, these supervised machine-learning systems can output a fraudulent transaction score for any new current transaction.

Alternatively, if labeled transaction samples are unavailable, illustrative embodiments may utilize an unsupervised machine learning system for the fraud scoring function S( ). An unsupervised machine learning system, such as, for example, a one-class support vector machine, can find transactions that are unusual or different from other transactions. Here, illustrative embodiments may require domain knowledge to give the system a hint on how certain features affect the fraudulent transaction scores, such as positively or negatively.

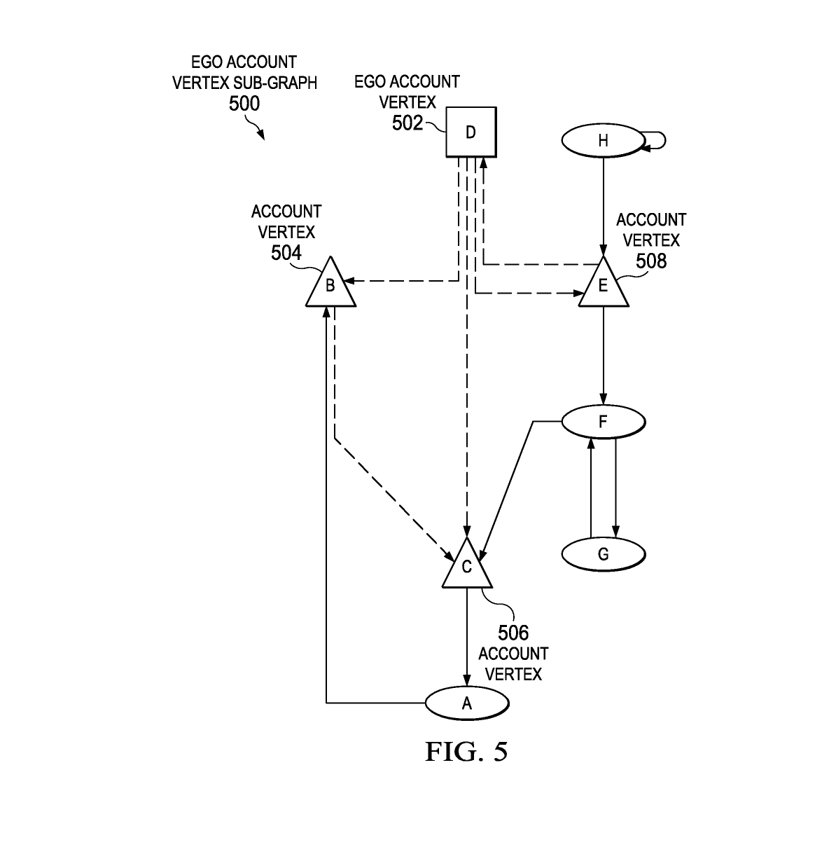

With reference now to FIG. 5, a diagram of an example of an ego account vertex sub-graph is depicted in accordance with an illustrative embodiment. Ego account vertex sub-graph 500 may be included in a transaction payment relationship graph, such as, for example, transaction payment relationship graph 406 in FIG. 4. In other words, ego account vertex sub-graph 500 is an egonet or a sub-graph of a transaction payment relationship graph, which is centered on a single vertex (e.g., egonode), such as ego account vertex 502 D, such that any vertex connected to ego account vertex 502 within ego account vertex sub-graph 500 is connected by an edge path of length not greater than “k”. It should be noted that in most cases k is equal to 1 for scalability and in many transaction payment relationship graphs even smaller values for k may yield an entire transaction payment relationship graph. In this example, vertices connected to ego account vertex 502 D within ego account vertex sub-graph 500 by an edge path of length 1 are account vertex 504 B, account vertex 506 C, and account vertex 508 E. In other words, ego account vertex 502 D, account vertex 504 B, account vertex 506 C, and account vertex 508 E comprise ego account vertex sub-graph 500. Also, it should be noted that edge paths connecting these vertices comprising ego account vertex sub-graph 500 are shown as dashed lines for illustration purposes only.

For small values of k, an ego account vertex sub-graph is a good definition of a community of vertices within a transaction payment relationship graph. A clique is a special type of ego account vertex sub-graph where a transaction exists from any source account vertex X in the ego account vertex sub-graph to any destination account vertex Y. To score a transaction, the data processing system determines whether or not destination account vertex Y is in source account vertex X's ego account vertex sub-graph (e.g., whether a prior transaction exists between source account vertex X and destination account vertex Y or from vertex Y to vertex X) or how the inclusion of destination account vertex Y into source account vertex X's ego account vertex sub-graph will affect the features of the ego account vertex sub-graph corresponding to source account vertex X.

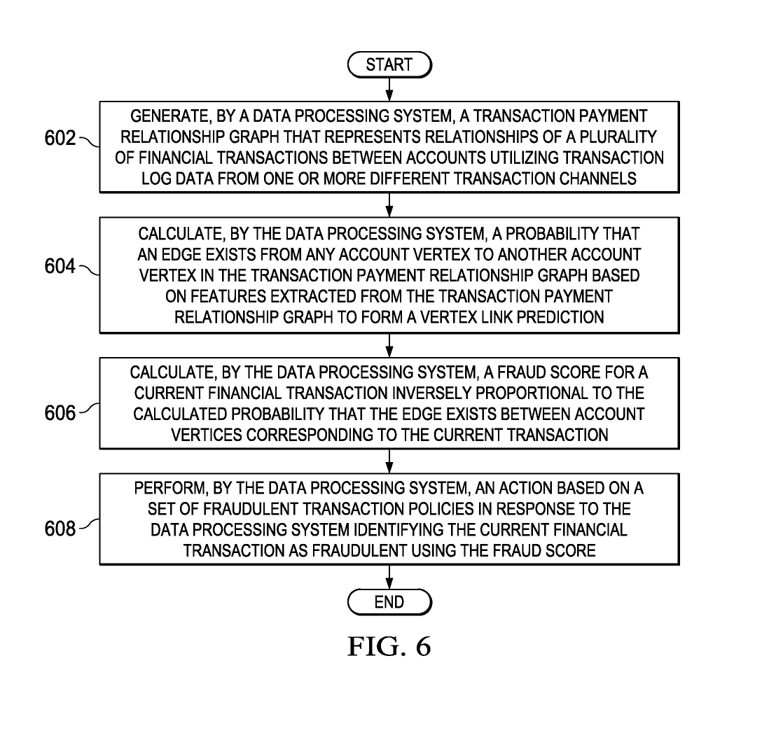

With reference now to FIG. 6, a flowchart illustrating a process for identifying fraudulent transactions is shown in accordance with an illustrative embodiment. The process shown in FIG. 6 may be implemented in a data processing system, such as, for example, server 104 or client 110 in FIG. 1 and data processing system 200 in FIG. 2.

The process begins when the data processing system generates a transaction payment relationship graph that represents relationships of a plurality of financial transactions between accounts utilizing transaction log data from one or more different transaction channels (step 602). In addition, the data processing system calculates a probability that an edge exists from any account vertex to another account vertex in the transaction payment relationship graph based on features extracted from the transaction payment relationship graph to form a vertex link prediction (step 604). Further, the data processing system calculates a fraud score for a current financial transaction inversely proportional to the calculated probability that the edge exists between account vertices corresponding to the current transaction (step 606). Furthermore, the data processing system performs an action based on a set of fraudulent transaction polices in response to the data processing system identifying the current financial transaction as fraudulent using the fraud score (step 608). Thereafter, the process terminates.

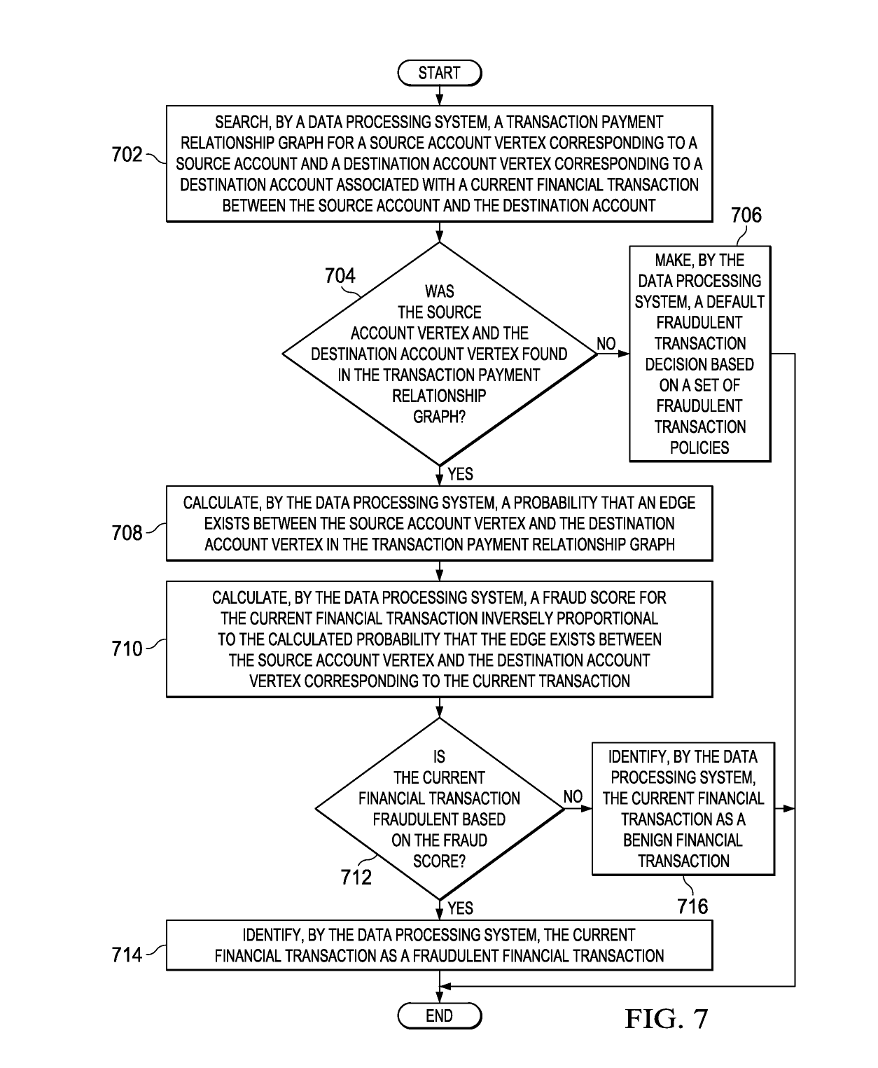

With reference now to FIG. 7, a flowchart illustrating another process for identifying a fraudulent transaction is shown in accordance with an alternative illustrative embodiment. The process shown in FIG. 7 may be implemented in a data processing system, such as, for example, server 104 or client 110 in FIG. 1 and data processing system 200 in FIG. 2.

The process begins when the data processing system searches a transaction payment relationship graph for a source account vertex corresponding to a source account and a destination account vertex corresponding to a destination account associated with a current financial transaction between the source account and the destination account (step 702). Afterward, the data processing system makes a determination as to whether the source account vertex and the destination account vertex was found in the transaction payment relationship graph (step 704). If the data processing system determines that the source account vertex and the destination account vertex was not found in the transaction payment relationship graph, no output of step 704, then the data processing system makes a default fraudulent transaction decision based on a set of fraudulent transaction policies (step 706). Thereafter, the process terminates.

If the data processing system determines that the source account vertex and the destination account vertex was found in the transaction payment relationship graph, yes output of step 704, then the data processing system calculates a probability that an edge exists between the source account vertex and the destination account vertex in the transaction payment relationship graph (step 708). Subsequently, the data processing system calculates a fraud score for the current financial transaction inversely proportional to the calculated probability that the edge exists between the source account vertex and the destination account vertex corresponding to the current transaction (step 710).

Afterward, the data processing system makes a determination as to whether the current financial transaction is fraudulent based on the fraud score (step 712). If the data processing system determines that the current financial transaction is fraudulent based on the fraud score, yes output of step 712, then the data processing system identifies the current financial transaction as a fraudulent financial transaction (step 714) and the process terminates thereafter. If the data processing system determines that the current financial transaction is not fraudulent based on the fraud score, no output of step 712, then the data processing system identifies the current financial transaction as a benign financial transaction (step 716) and the process terminates thereafter.

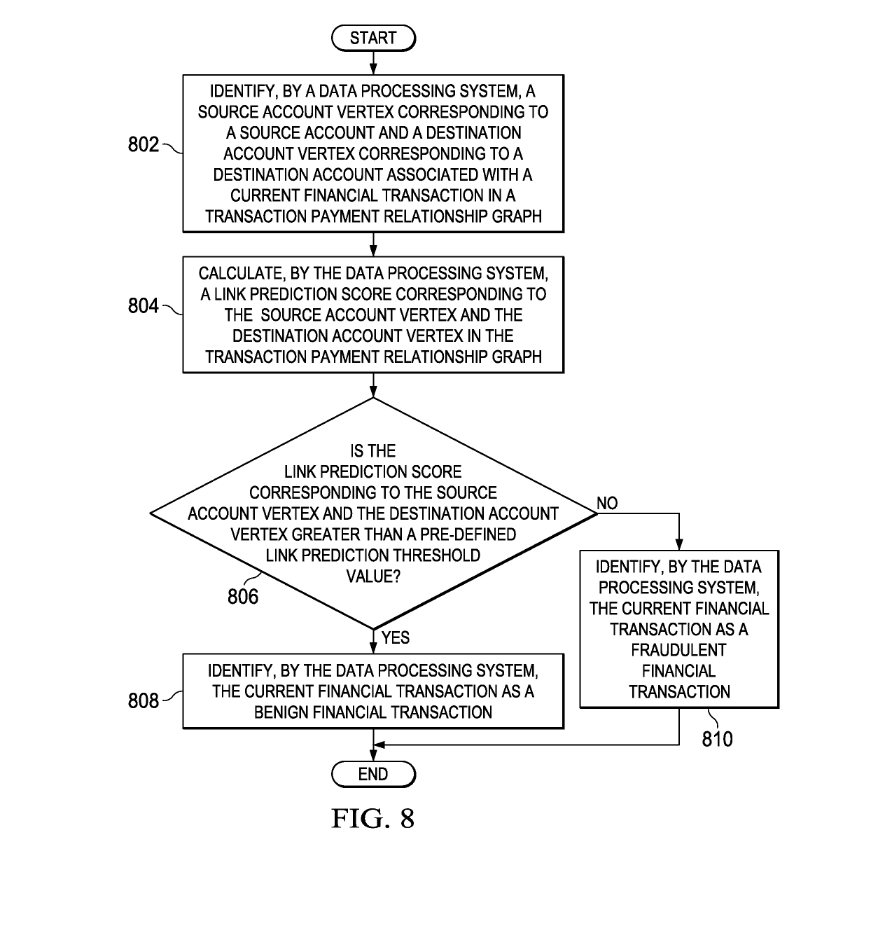

With reference now to FIG. 8, a flowchart illustrating another process for identifying a fraudulent transaction is shown in accordance with an alternative illustrative embodiment. The process shown in FIG. 8 may be implemented in a data processing system, such as, for example, server 104 or client 110 in FIG. 1 and data processing system 200 in FIG. 2.

The process begins when the data processing system identifies a source account vertex corresponding to a source account and a destination account vertex corresponding to a destination account associated with a current financial transaction in a transaction payment relationship graph (step 802). In addition, the data processing system calculates a link prediction score corresponding to the source account vertex and the destination account vertex in the transaction payment relationship graph (step 804). Afterward, the data processing system makes a determination as to whether the link prediction score corresponding to the source account vertex and the destination account vertex is greater than a pre-defined link prediction threshold value (step 806).

If the data processing system determines that the link prediction score corresponding to the source account vertex and the destination account vertex is greater than or equal to a pre-defined link prediction threshold value, yes output of step 806, then the data processing system identifies the current financial transaction as a benign financial transaction (step 808) and the process terminates thereafter. If the data processing system determines that the link prediction score corresponding to the source account vertex and the destination account vertex is less than the pre-defined link prediction threshold value, no output of step 806, then the data processing system identifies the current financial transaction as a fraudulent financial transaction (step 810) and the process terminates thereafter.

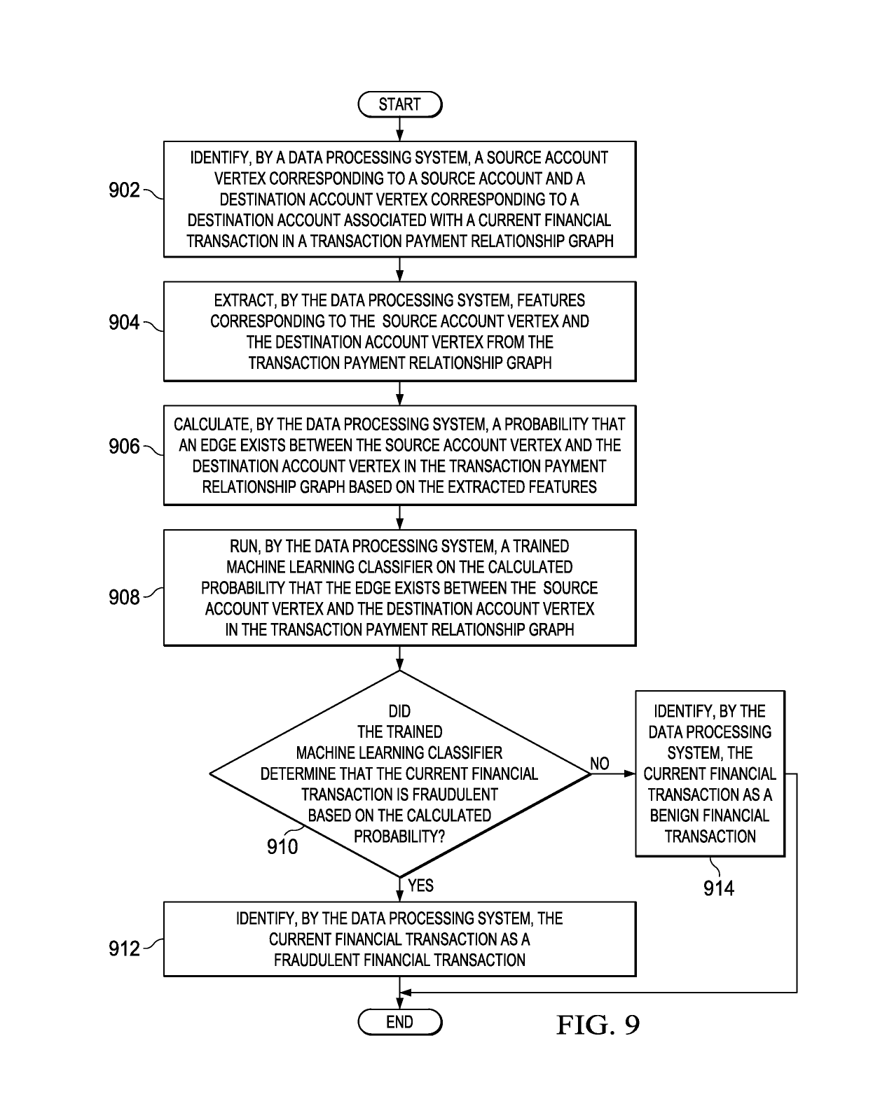

With reference now to FIG. 9, a flowchart illustrating another process for identifying a fraudulent transaction is shown in accordance with an alternative illustrative embodiment. The process shown in FIG. 9 may be implemented in a data processing system, such as, for example, server 104 or client 110 in FIG. 1 and data processing system 200 in FIG. 2.

The process begins when the data processing system identifies a source account vertex corresponding to a source account and a destination account vertex corresponding to a destination account associated with a current financial transaction in a transaction payment relationship graph (step 902). In addition, the data processing system extracts features corresponding to the source account vertex and the destination account vertex from the transaction payment relationship graph (step 904). Further, the data processing system calculates a probability that an edge exists between the source account vertex and the destination account vertex in the transaction payment relationship graph based on the extracted features (step 906).

Afterward, the data processing system runs a trained machine learning classifier on the calculated probability that the edge exists between the source account vertex and the destination account vertex in the transaction payment relationship graph (step 908). Subsequently, the data processing system makes a determination as to whether the trained machine learning classifier determined that the current financial transaction is fraudulent based on the calculated probability (step 910). If the data processing system determined that the trained machine learning classifier did determine that the current financial transaction is fraudulent based on the calculated probability, yes output of step 910, then the data processing system identifies the current financial transaction as a fraudulent financial transaction (step 912) and the process terminates thereafter. If the data processing system determined that the trained machine learning classifier did not determine that the current financial transaction is fraudulent based on the calculated probability, no output of step 910, then the data processing system identifies the current financial transaction as a benign financial transaction (step 914) and the process terminates thereafter.

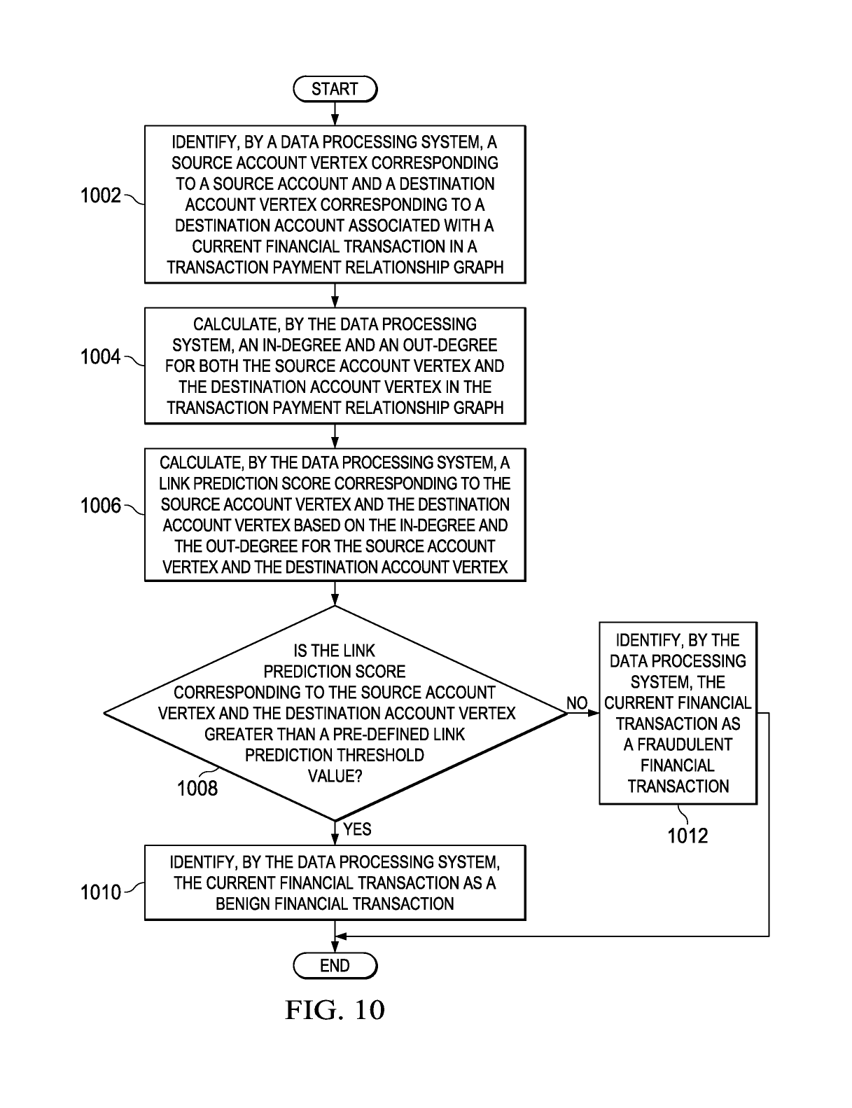

With reference now to FIG. 10, a flowchart illustrating another process for identifying a fraudulent transaction is shown in accordance with an alternative illustrative embodiment. The process shown in FIG. 10 may be implemented in a data processing system, such as, for example, server 104 or client 110 in FIG. 1 and data processing system 200 in FIG. 2.

The process begins when the data processing system identifies a source account vertex corresponding to a source account and a destination account vertex corresponding to a destination account associated with a current financial transaction in a transaction payment relationship graph (step 1002). In addition, the data processing system identifies an in-degree and an out-degree for both the source account vertex and the destination account vertex in the transaction payment relationship graph (step 1004). Further, the data processing system calculates a link prediction score corresponding to the source account vertex and the destination account vertex based on the in-degree and the out-degree for the source account vertex and the destination account vertex (step 1006). Higher out-degrees of source account vertices provide a higher link prediction score and higher in-degrees of destination account vertices imply a higher link prediction score. A higher link prediction score indicates that the current financial transaction is less likely to be fraudulent.

After calculating the link prediction score in step 1006, the data processing system makes a determination as to whether the link prediction score corresponding to the source account vertex and the destination account vertex is greater than a pre-defined link prediction threshold value (step 1008). If the data processing system determines that the link prediction score corresponding to the source account vertex and the destination account vertex is greater than the pre-defined link prediction threshold value, yes output of step 1008, then the data processing system identifies the current financial transaction as a benign financial transaction (step 1010) and the process terminates thereafter. If the data processing system determines that the link prediction score corresponding to the source account vertex and the destination account vertex is less than the pre-defined link prediction threshold value, no output of step 1008, then the data processing system identifies the current financial transaction as a fraudulent financial transaction (step 1012) and the process terminates thereafter.

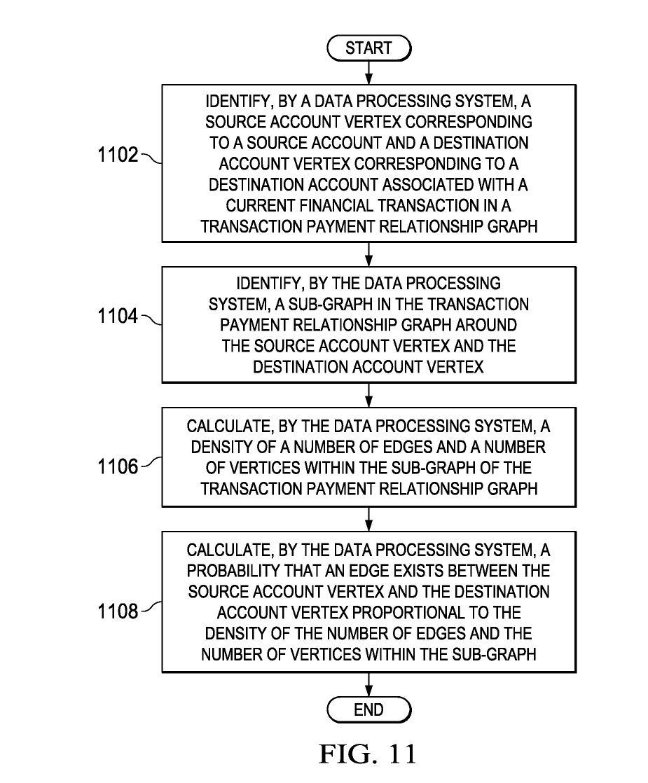

With reference now to FIG. 11, a flowchart illustrating a process for calculating a probability that an edge exists between source and destination account vertices is shown in accordance with an illustrative embodiment. The process shown in FIG. 11 may be implemented in a data processing system, such as, for example, server 104 or client 110 in FIG. 1 and data processing system 200 in FIG. 2.

The process begins when the data processing system identifies a source account vertex corresponding to a source account and a destination account vertex corresponding to a destination account associated with a current financial transaction in a transaction payment relationship graph (step 1102). In addition, the data processing system identifies a sub-graph in the transaction payment relationship graph around the source account vertex and the destination account vertex (step 1104). Further, the data processing system calculates a density of a number of edges and a number of vertices within the sub-graph of the transaction payment relationship graph (step 1106). Furthermore, the data processing system calculates a probability that an edge exists between the source account vertex and the destination account vertex proportional to the density of the number of edges and the number of vertices within the sub-graph (step 1108). Thereafter, the process terminates.

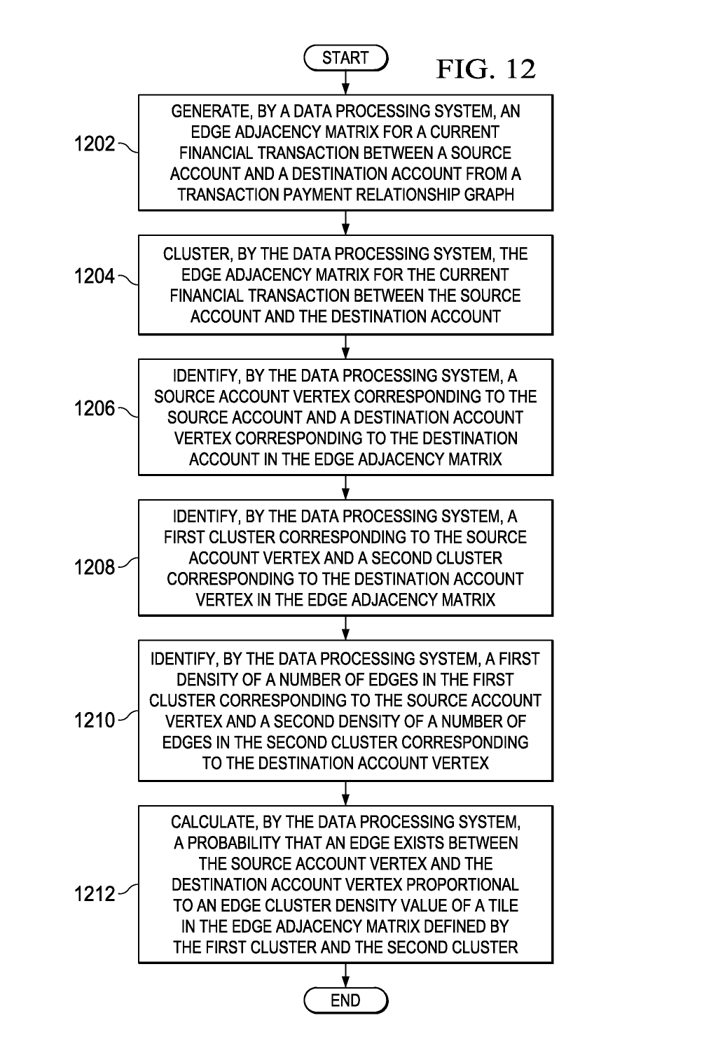

With reference now to FIG. 12, a flowchart illustrating another process for calculating a probability that an edge exists between source and destination account vertices is shown in accordance with an alternative illustrative embodiment. The process shown in FIG. 12 may be implemented in a data processing system, such as, for example, server 104 or client 110 in FIG. 1 and data processing system 200 in FIG. 2.

The process begins when the data processing system generates an edge adjacency matrix for a current financial transaction between a source account and a destination account from a transaction payment relationship graph (step 1202). In addition, the data processing system clusters the edge adjacency matrix for the current financial transaction between the source account and the destination account (step 1204). Further, the data processing system identifies a source account vertex corresponding to the source account and a destination account vertex corresponding to the destination account in the edge adjacency matrix (step 1206).

Furthermore, the data processing system identifies a first cluster corresponding to the source account vertex and a second cluster corresponding to the destination account vertex in the edge adjacency matrix (step 1208). The data processing system also identifies a first density of a number of edges in the first cluster corresponding to the source account vertex and a second density of a number of edges in the second cluster corresponding to the destination account vertex (step 1210). Moreover, the data processing system calculates a probability that an edge exists between the source account vertex and the destination account vertex proportional to an edge cluster density value of a tile in the edge adjacency matrix defined by the first cluster and the second cluster (step 1212). Thereafter, the process terminates.

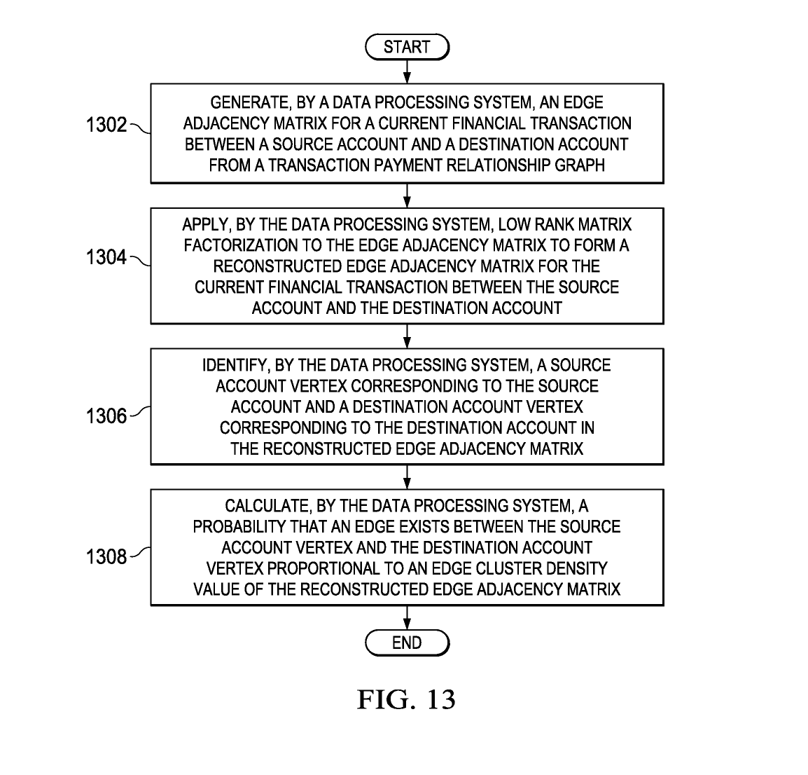

With reference now to FIG. 13, a flowchart illustrating another process for calculating a probability that an edge exists between source and destination account vertices is shown in accordance with an alternative illustrative embodiment. The process shown in FIG. 13 may be implemented in a data processing system, such as, for example, server 104 or client 110 in FIG. 1 and data processing system 200 in FIG. 2.

The process begins when the data processing system generates an edge adjacency matrix for a current financial transaction between a source account and a destination account from a transaction payment relationship graph (step 1302). Afterward, the data processing system applies low rank matrix factorization to the edge adjacency matrix to form a reconstructed edge adjacency matrix for the current financial transaction between the source account and the destination account (step 1304). In addition, the data processing system identifies a source account vertex corresponding to the source account and a destination account vertex corresponding to the destination account in the reconstructed edge adjacency matrix (step 1306). Further, the data processing system calculates a probability that an edge exists between the source account vertex and the destination account vertex proportional to an edge cluster density value of the reconstructed edge adjacency matrix (step 1308). Thereafter, the process terminates.

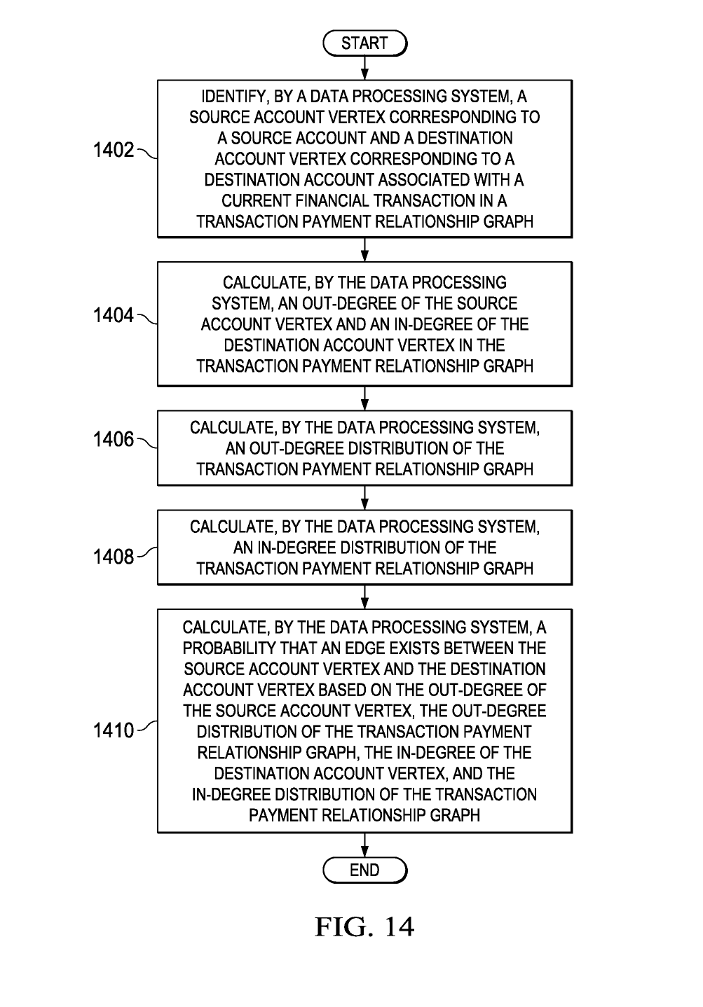

With reference now to FIG. 14, a flowchart illustrating another process for calculating a probability that an edge exists between source and destination account vertices is shown in accordance with an alternative illustrative embodiment. The process shown in FIG. 14 may be implemented in a data processing system, such as, for example, server 104 or client 110 in FIG. 1 and data processing system 200 in FIG. 2.

The process begins when the data processing system identifies a source account vertex corresponding to a source account and a destination account vertex corresponding to a destination account associated with a current financial transaction in a transaction payment relationship graph (step 1402). In addition, the data processing system calculates an out-degree of the source account vertex and an in-degree of the destination account vertex in the transaction payment relationship graph (step 1404).

Further, the data processing system calculates an out-degree distribution of the transaction payment relationship graph (step 1406). The data processing system also calculates an in-degree distribution of the transaction payment relationship graph (step 1408). Furthermore, the data processing system calculates a probability that an edge exists between the source account vertex and the destination account vertex based on the out-degree of the source account vertex, the out-degree distribution of the transaction payment relationship graph, the in-degree of the destination account vertex, and the in-degree distribution of the transaction payment relationship graph (step 1410). Thereafter, the process terminates.

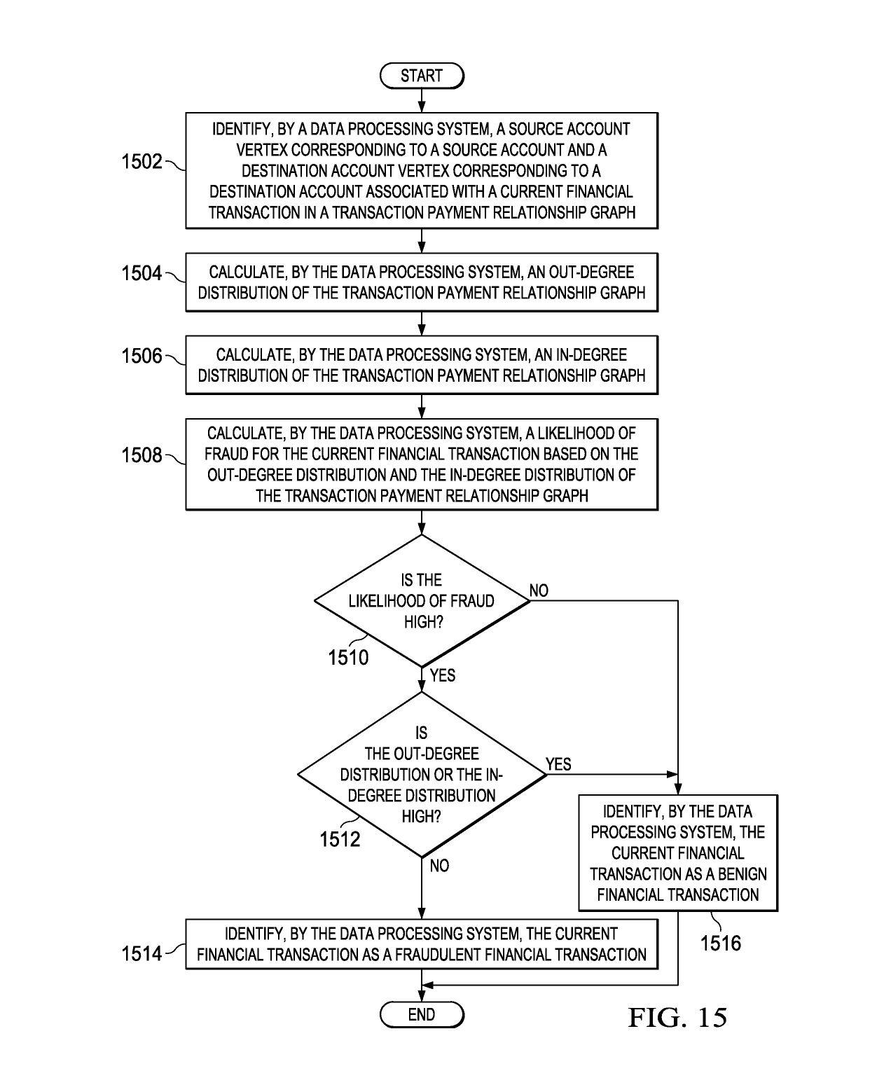

With reference now to FIG. 15, a flowchart illustrating a process for calculating a likelihood of fraud for a current financial transaction is shown in accordance with an alternative illustrative embodiment. The process shown in FIG. 15 may be implemented in a data processing system, such as, for example, server 104 or client 110 in FIG. 1 and data processing system 200 in FIG. 2.

The process begins when the data processing system identifies a source account vertex corresponding to a source account and a destination account vertex corresponding to a destination account associated with a current financial transaction in a transaction payment relationship graph (step 1502). In addition, the data processing system calculates an out-degree distribution of the transaction payment relationship graph (step 1504). The data processing system also calculates an in-degree distribution of the transaction payment relationship graph (step 1506). Further, the data processing system calculates a likelihood of fraud for the current financial transaction based on the out-degree distribution and the in-degree distribution of the transaction payment relationship graph (step 1508).

Afterward, the data processing system makes a determination as to whether the likelihood of fraud is high (step 1510). If the data processing system determines that the likelihood of fraud is high, yes output of step 1510, then the data processing system makes another determination as to whether the out-degree distribution or the in-degree distribution is high (step 1512). If the data processing system determines that the out-degree distribution or the in-degree distribution is low, no output of step 1512, then the data processing system identifies the current financial transaction as a fraudulent financial transaction (step 1514). Thereafter, the process terminates.

Returning again to step 1510, if the data processing system determines that the likelihood of fraud is low, no output of step 1510, then the data processing system identifies the current financial transaction as a benign financial transaction (step 1516). Thereafter, the process terminates. Returning again to step 1512, if the data processing system determines that the out-degree distribution or the in-degree distribution is high, yes output of step 1512, then the process proceeds to step 1516 where the data processing system identifies the current financial transaction as a benign financial transaction and the process terminates thereafter.

Thus, illustrative embodiments provide a computer-implemented method, data processing system, and computer program product for identifying fraudulent transactions by predicting a probability that an edge exists between two account vertices corresponding to a current financial transaction in a transaction payment relationship graph. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for identifying fraudulent transactions, the computer-implemented method comprising:
generating, by a data processing system, a transaction payment relationship graph that represents relationships of a plurality of financial transactions between accounts utilizing transaction log data from one or more different transaction channels;
calculating, by the data processing system, a probability that an edge exists from any account vertex to another account vertex in the transaction payment relationship graph based on features extracted from the transaction payment relationship graph, wherein the calculated probability that the edge exists between account vertices corresponding to a current financial transaction is a vertex link prediction; and
calculating, by the data processing system, a fraud score for the current financial transaction based on the calculated probability that the edge exists between account vertices corresponding to the current transaction.

2. The computer-implemented method of claim 1, wherein the data processing system calculates the fraud score for the current financial transaction inversely proportional to the calculated probability that the edge exists between account vertices corresponding to the current transaction.

3. The computer-implemented method of claim 1, wherein the data processing system calculates the fraud score for the current financial transaction using a threshold function, and wherein the data processing system labels the current financial transaction as fraudulent in response to the data processing system determining that the calculated probability that the edge exists between the account vertices corresponding to the current financial transaction is less than a predefined probability threshold value.

4. The computer-implemented method of claim 1, wherein the data processing system calculates the fraud score for the current financial transaction using a machine learning classifier trained on previously labeled fraudulent financial transactions.

5. The computer-implemented method of claim 1, wherein the vertex link prediction is based on features of the account vertices corresponding to the current financial transaction, and wherein the features of the account vertices are degree features of the account vertices corresponding to the current financial transaction.

6. The computer-implemented method of claim 1, wherein the vertex link prediction is based on at least one of an out-degree of a source account vertex and an in-degree of a destination account vertex corresponding to the current financial transaction.

7. The computer-implemented method of claim 1, wherein the vertex link prediction is based on the features of a source account vertex and a destination account vertex corresponding to the current financial transaction, and wherein the features are at least one of a type of account corresponding to the source account vertex and the destination account vertex, geographic locations of accounts corresponding to the source account vertex and the destination account vertex, and a type of merchant corresponding to the current financial transaction.

8. The computer-implemented method of claim 1, wherein the data processing system trains a machine learning classifier to determine whether an account corresponding to a source account vertex having a first set of features will pay another account corresponding to a destination account vertex having a second set of features.

9. The computer-implemented method of claim 1, wherein the calculated probability that the edge exists between the account vertices corresponding to the current financial transaction is proportional to an out-degree of a source account vertex and an in-degree of a destination account vertex, and wherein higher out-degrees of source account vertices and higher in-degrees of destination account vertices imply that corresponding financial transactions are less likely to be fraudulent.

10. The computer-implemented method of claim 1, wherein the vertex link prediction is based on a structure of the transaction payment relationship graph.

11. The computer-implemented method of claim 1, wherein a probability of adding the edge to the transaction payment relationship graph is proportional to a local edge density of the transaction payment relationship graph.

12. The computer-implemented method of claim 1, wherein the data processing system clusters an edge adjacency matrix and calculates the vertex link prediction proportional to an edge cluster density value.

13. The computer-implemented method of claim 12, wherein the data processing system applies low rank matrix factorization to the edge adjacency matrix and calculates the vertex link prediction proportional to the edge cluster density value in a reconstructed edge adjacency matrix, and wherein the low rank matrix factorization is one of singular value decomposition or non-negative matrix factorization.

14. The computer-implemented method of claim 1, wherein the vertex link prediction is based on a number of distinct edges that connect two account vertices in the transaction payment relationship graph.

15. The computer-implemented method of claim 1, wherein the vertex link prediction is based on features of accounts, edges, and structure of the transaction payment relationship graph.

16. The computer-implemented method of claim 1, wherein the data processing system applies tensor decomposition to a set of financial transactions of the transaction payment relationship graph and calculates the vertex link prediction proportional to a vertex link prediction value in a reconstructed tensor.

17. The computer-implemented method of claim 1, wherein the data processing system applies collective matrix factorization to relationships between features of accounts, edges, and structure of the transaction payment relationship graph and calculates the vertex link prediction proportional to a reconstructed edge cluster density value in an edge adjacency matrix.

18. The computer-implemented method of claim 1, wherein the vertex link prediction is proportional to a confidence value corresponding to association rules mined from features corresponding to a set of destination account vertices for each source account vertex.

19. The computer-implemented method of claim 1, wherein the data processing system applies sequence mining to a temporally ordered set of destination accounts that a source account pays.

20. The computer-implemented method of claim 1, wherein the data processing system applies the vertex link prediction to a sub-graph of the transaction payment relationship graph.

21. The computer-implemented method of claim 20, wherein the data processing system builds the sub-graph from all financial transaction and account information corresponding to account vertices within k number of hops of source and destination account vertices corresponding to the current financial transaction.

22. A data processing system for identifying fraudulent transactions, the data processing system comprising:
a bus system;
a storage device connected to the bus system, wherein the storage device stores program instructions; and
a processor connected to the bus system, wherein the processor executes the program instructions to generate a transaction payment relationship graph that represents relationships of a plurality of financial transactions between accounts utilizing transaction log data from one or more different transaction channels; calculate a probability that an edge exists from any account vertex to another account vertex in the transaction payment relationship graph based on features extracted from the transaction payment relationship graph, wherein the calculated probability that the edge exists between account vertices corresponding to a current financial transaction is a vertex link prediction; and calculate a fraud score for the current financial transaction based on the calculated probability that the edge exists between account vertices corresponding to the current transaction.

23. A computer program product for identifying fraudulent transactions, the computer program product comprising a computer readable storage medium having program instructions embodied therewith, the program instructions executable by a data processing system to cause the data processing system to perform a method comprising:
generating, by the data processing system, a transaction payment relationship graph that represents relationships of a plurality of financial transactions between accounts utilizing transaction log data from one or more different transaction channels;
calculating, by the data processing system, a probability that an edge exists from any account vertex to another account vertex in the transaction payment relationship graph based on features extracted from the transaction payment relationship graph, wherein the calculated probability that the edge exists between account vertices corresponding to a current financial transaction is a vertex link prediction; and
calculating, by the data processing system, a fraud score for the current financial transaction based on the calculated probability that the edge exists between account vertices corresponding to the current transaction.

24. The computer program product of claim 23, wherein the data processing system calculates the fraud score for the current financial transaction inversely proportional to the calculated probability that the edge exists between account vertices corresponding to the current transaction.

25. The computer program product of claim 23, wherein the data processing system calculates the fraud score for the current financial transaction using a threshold function, and wherein the data processing system labels the current financial transaction as fraudulent in response to the data processing system determining that the calculated probability that the edge exists between the account vertices corresponding to the current financial transaction is less than a predefined probability threshold value.
